(19) United States
(12) Patent Application Publication
(10) Pub. No.: US 2006/0117090 A1
(43) Pub. Date: Jun. 1, 2006

(54) System to allow content sharing

(75) Inventors: Nicolaas Willem Schellingerhout, Eindhoven (NL); Maarten Peter Bodlaender, Eindhoven (NL); Willem Bulthuis, Eindhoven (NL); Pieter Voorwinden, Eindhoven (NL); Alexandre Sinitsyn, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/538,572

(22) PCT Filed: Nov. 14, 2003
(86) PCT No.: PCT/IB03/05205

§ 371 Date: Jun. 15, 2005

(30) Foreign Application Priority Data
Dec. 17, 2002 (EP) 02080502.4

(51) Int. Cl. G06F 15/16; G06F 15/173

(52) U.S. Cl. 709/217; 709/223

(57) ABSTRACT

The present invention relates to a method and a system for converting digital rights. The invention is based on the idea that a mechanism is introduced, by which it is possible to convert an unlimited right into at least one limited digital right, which gives a user access to the content a limited number of times. The present invention is advantageous since if a proprietor of an unlimited right wants to share his/her unlimited right with a friend, he/she does not have to give up the unlimited right to the friend. If the proprietor would like to share the right with other content consumers, the unlimited right can be converted into a number of limited rights, wherein these limited rights can be shared with the other content consumers.

The present invention relates to a method and a system for converting digital rights.

In today's information society, the rapid spread of digital information has given birth to the concept of digital rights management (DRM). This concept is used to protect the rights of a creator of the digital information, typically called the digital content, as well as the rights of an information provider distributing the information or content. This concept is applicable to information distributed via any type of media, such as the Internet, a CD, a DVD or the like. It is also applicable to any type of information, for example audio, video, text etc. DRM technologies are thus used to protect copyrighted content from being pirated, misused and/or wrongly distributed.

Information can be distributed between a number of actors. The distribution can, for example, take place between a server and a stand-alone computer, between two or more stand-alone computers, between a mobile phone and a computer etc. The actual information distribution can attain many different forms; information is downloaded for permanent storage on a hard disk, information is streamed from a server, whereby permanent storage of the information is disabled, a single information copy is distributed, a large number of copies are distributed etc. As clearly can be seen, there are many aspects to consider when designing DRM systems.

A common digital right is the unlimited digital right, which gives its proprietor access to content, to which the right is associated, an unlimited number of times. This access can include various different types of access, for example “play”, “copy”, “burn to CD-R”, “transfer”, “download” etc. Thus, a typical digital right associated with audio content is “play unlimited”. However, limited digital rights are also common, giving its proprietor access to content, to which the rights are associated, a limited number of times. This access can also include various different types of access, for example “play for 24 hours”, “copy once”, “burn to CD-R once”, “transfer to a specific user group” etc.

U.S. Pat. No. 5,629,980 discloses a system for controlling use and distribution of digital works. Usage rights are associated to the digital work, the usage rights defining how a digital work can be used and distributed by a buyer of the work. Digital works are stored in a repository. A repository will process each request to access a digital work by examining the corresponding usage rights. Digital work playback devices coupled to the repository containing the work are used to play, display or print the work.

A problem with U.S. Pat. No. 5,629,980 is that it does not offer any possibility for a proprietor of a usage right, which gives the user access to the work an unlimited number of times, to share the work with other users giving these other users access to the work a limited number of times.

An object of the present invention is to provide a system and a method by which it is possible to share digital content and an associated unlimited digital right without harming the proprietor of the copyrighted content.

This object is achieved by a method for converting digital rights according to claim 1 and a system for converting digital rights according to claim 5. Preferred embodiments are defined by the dependent claims.

According to a first aspect of the invention, a method is provided in which digital content and an associated unlimited digital right is stored, which unlimited digital right gives a proprietor of the unlimited right access to the content an unlimited number of times. When receiving a conversion instruction, the unlimited digital right is converted into at least one limited digital right. The limited digital right gives a proprietor of the limited right access to the content a limited number of times.

According to a second aspect of the invention, a system is provided comprising storing means arranged to store digital content and an associated unlimited digital right. The unlimited digital right gives a proprietor of the unlimited right access to the content an unlimited number of times. The system further comprises processing means arranged to convert the unlimited digital right into at least one limited digital right, when the system receives an instruction in accordance therewith. The at least one limited digital right gives a proprietor of the limited right access to the content a limited number of times.

The invention is based on the idea that a mechanism is introduced, by which it is possible to convert an unlimited right into at least one limited digital right, which gives a proprietor of the limited digital right access to the content a limited number of times. It is possible to convert an unlimited right into either a single limited digital right which allows a given limited number of accesses, or a number of limited digital rights which together allow the same given limited number of accesses as the single limited digital right. In other words, an unlimited right can be converted into one single limited digital right giving its proprietor the right to access the content, for example, 50 times. Alternatively, the same unlimited right can be converted into 50 separate limited digital rights each giving its proprietor the right to access the content one time. Moreover, the limited digital rights can be created in such a way that each of the limited rights allow the proprietor of the respective right a different number of accesses. For example, the unlimited right can be converted into 10 single limited digital rights giving its proprietor the right to access the content 2 times, 5 single limited digital rights giving the proprietor the right to 3 accesses and one single limited digital right giving the proprietor the right to 15 accesses. The total number of accesses is still 50. When converting the unlimited right into at least one limited right, an agreement must be made on how many accesses an unlimited right entails. Alternatively, this is agreed upon in advance.

The above described concept is advantageous since if a proprietor of an unlimited right wants to share his/her unlimited right with a friend, he/she does not have to give up the unlimited right to the friend. If the proprietor would like to share the right with other content consumers, the unlimited right can be converted into a number of limited rights, wherein these limited rights can be shared with the other content consumers. Not only the consumer holding the unlimited right at the moment would have the possibility to access the content. Once the unlimited right has been converted and at least one limited right has been given to a content consumer, it is possible for that specific consumer to distribute her limited right to another consumer, not only the proprietor of the unlimited right that was converted is entitled to distribute limited rights.

Further, at the end of a transaction of the limited rights, the given number of accesses associated with the limited rights does not exceed the number that was agreed upon. Thereby the proprietor of the copyrighted content and/or the distributor is not harmed. Rather, the conversion from an unlimited right to a number of limited rights promotes the content and stimulates sales for the proprietor of the copyrighted content and the content provider.

According to an embodiment of the invention, the digital content and the associated digital rights are stored at a server of a digital content provider and the conversion of an unlimited right into a number of limited rights is performed at the server, when the server receives a converting instruction from a device with computing capabilities operated by the proprietor of the digital rights. The proprietor of the digital rights, which rights are associated with the content, thereby have to establish connection with the server when converting the unlimited right and accessing the content. This has the advantage that since the digital content and the associated rights are stored on a server of a digital content provider, the administration and managing of digital rights for the content provider is rather easy, since rights are not distributed outside the server. This also implies that advanced security facilities for protecting rights need not be employed. As the rights are kept within the controlled framework of the server, an unauthorized third party is prevented from eavesdropping on a network, by which the server and content consumers are interconnected, and accessing/stealing the rights.

According to another embodiment of the invention, digital content and associated digital rights are distributed from the server of a digital content provider, for storage at a device with computing capabilities operated by the proprietor of the digital rights. The fact that the digital content and the associated rights are stored at the device of the right proprietor is advantageous, since this gives the proprietor a larger degree of freedom in handling and distributing the contents and rights. The proprietor need not, apart from the step of converting an unlimited right to limited rights, operate via the server. Another advantage is that, when accessing the digital content, whether the access is of type play, copy, transfer etc., the proprietor need not be in contact with the server of the content provider at the time of access, since the content and associated rights are stored at the device of the proprietor of the digital rights.

According to yet another embodiment of the present invention, the conversion of the unlimited digital right into at least one limited digital right, as well as the storing of digital content and the associated digital rights, is performed at the device with computing capabilities operated by the proprietor of the digital rights. To perform the conversion at the device of the digital right proprietor is advantageous, since it gives the proprietor a larger amount of freedom in handling the rights. It is not necessary for a proprietor to send a conversion instruction to the server via the network by which the proprietor and the content provider is interconnected. Consequently, the proprietor does not have to rely on a qualitative connection to the server, once the digital content and the associated right have been downloaded to the device. It also has the advantage that the distributor of the software module, typically the content provider or a partner to the provider, does not have to handle the conversion for content consumers connected to the server. DRM is sometimes experienced as restrictive to the content consumers. For content consumers to accept DRM, tools such as the present invention must be as smooth as possible to use when implemented in DRM systems.

Further features of, and advantages with, the present invention will become apparent when studying the appended claims and the following description. Those skilled in the art realize that different features of the present invention can be combined to create embodiments other than those described in the following. Many different alterations, modifications and combinations will become apparent for those skilled in the art. The described embodiments are therefore not intended to limit the scope of the invention, as defined by the appended claims.

Embodiments of the present invention will be described with reference made to the accompanying drawings, in which:

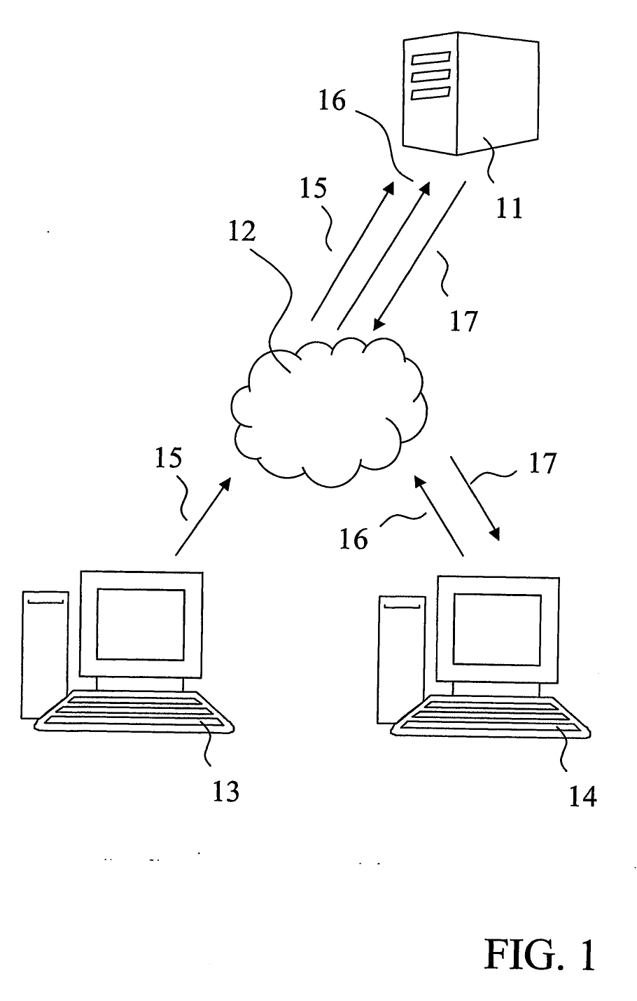

FIG. 1 shows a schematic representation of a system for converting digital rights according to an embodiment of the present invention;

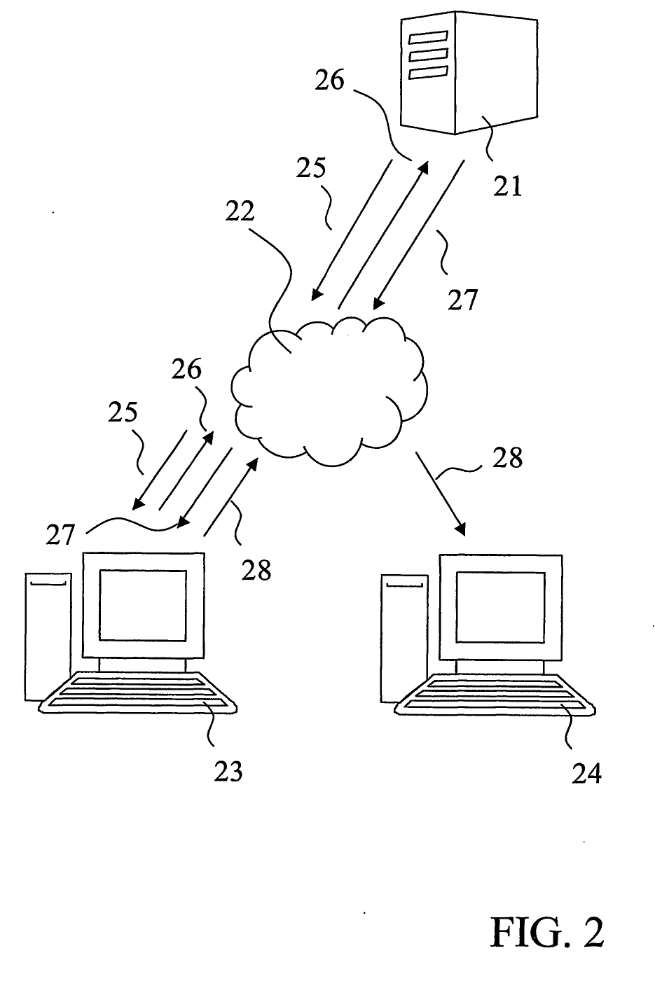

FIG. 2 shows a schematic representation of a system for converting digital rights according to another embodiment of the present invention; and

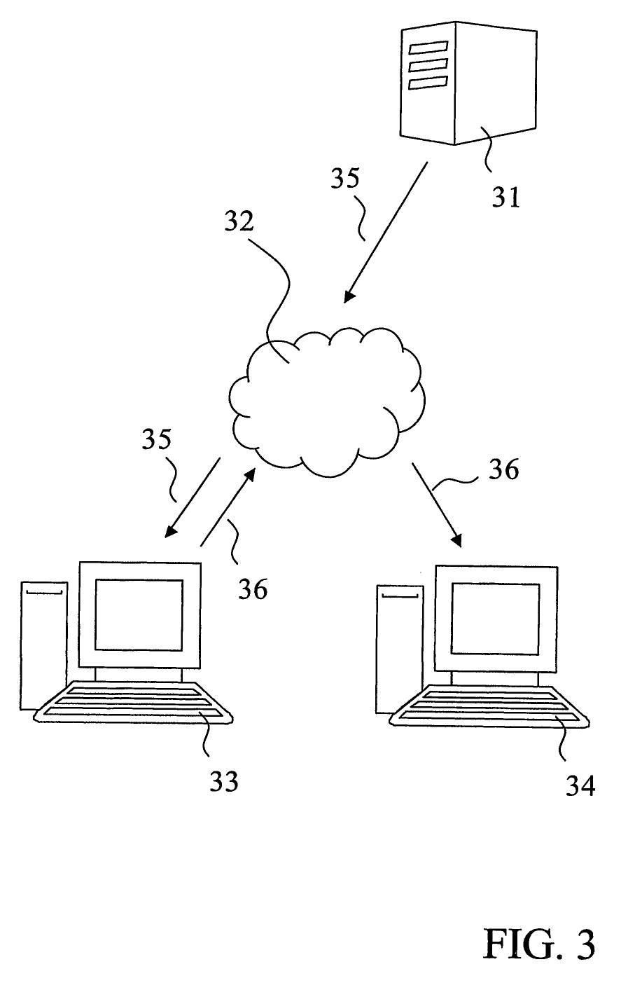

FIG. 3 shows a schematic representation of a system for converting digital rights according to yet another embodiment of the present invention.

FIG. 1 shows a schematic representation of a system for converting digital rights according to an embodiment of the present invention. A server 11 contains some storing means for storing digital content and digital rights associated with the content. As previously mentioned, a large number of digital rights exists, for example “play”, “copy”, “burn to CD-R”, “transfer”, “download” etc. In this exemplifying embodiment, for the sake of simplicity, the digital rights that are used include “play unlimited” and “play #N times”. The type of access given to a proprietor of a digital right is, in this case, consequently “play”. Those skilled in the art will realize that the following reasoning could be applied to virtually any type of access.

One way of indicating whether a right is unlimited or limited is to associate an integer with the right at the server 11. A negative value on the integer indicates an unlimited right and a positive value will indicate a limited right. The positive value will indicate how many times the content can be accessed by the proprietor of the right.

DRM systems incorporate more and more different business models which requires that the DRM system is sufficiently flexible to handle many different types of rights. To facilitate the management of the digital rights for participants in DRM systems, rights are expressed using digital rights management languages. It is to be understood that such languages can be employed in the present invention to express digital rights. These languages include ODRL (Open Digital Rights Language) and XrML (Extensible Rights Markup Language). DRM languages usually conforms to a standard language notation. ODRL and XrML both allows the rights to be expressed using XML (Extensible Markup Language) notation.

The server 11 is interfaced against a network 12, such as the Internet, via which network 12 a proprietor of a digital right by means of his/her device with computing capabilities, herein illustrated by computer 13, can activate a conversion mechanism at the server 11. The conversion mechanism preferably consist of a software module executed on a microprocessor implemented in the server 11. When the software module is activated by a proprietor of an unlimited right stored at the server 11, by sending 15 a conversion instruction designating the concerned unlimited right, the unlimited right is converted into one, or a number of, limited rights.

The instructing operation could be effected in a number of different ways, preferably the proprietor of the unlimited right(s) logs on to the site of a content provider running the server 11. The proprietor is presented to a list containing the rights tied to an account the proprietor has at this specific content provider. The unlimited right of interest is then marked using the mouse connected to computer 13. A message box will appear on the screen of the computer 13, which message box asks the proprietor “Convert unlimited right into a limited right giving 50 accesses?”. If the proprietor clicks “Yes”, the unlimited right will be converted into one limited right giving a proprietor 50 accesses. In this context, “a limited right giving 50 accesses” is equivalent with 50 separate limited rights each giving a proprietor one access, in the following referred to as “50 limited rights”. It shall also be made clear that “50 limited rights” is equivalent with, for example, 25 limited rights each giving its proprietor(s) the right to access the associated content 2 times or equivalent with 10 limited rights each giving the proprietor 5 accesses. If an unlimited right entails 50 accesses when being converted, the proprietor of the unlimited right can decide herself via the graphical user interface of the computer 13 how many separate limited rights the 50 accesses shall be distributed on. When the unlimited right is converted into limited rights, the limited rights are stored at the server 11.

As mentioned earlier, when converting the unlimited right into limited rights, an agreement must be made on how many accesses the conversion of an unlimited right entails. In the above example, an unlimited right is converted into 50 limited rights. This might be agreed upon at the time of conversion or alternatively, this is agreed upon in advance. This is something that the proprietor of the copyrighted content and the content provider legally have to agree upon and lies beyond the scope of the present invention. However, this agreement is not necessarily static, the conversion factor depends on the type of content and can change for any given content over time. Typically, for audio content such as a song, the newer the song, the less accesses it entails when converting the unlimited right to the song to a number of limited rights. This can be compared to retail stores selling CDs. A new CD normally entails full price, but after some time, the CD will be less expensive to promote sales.

Now, as the proprietor of the unlimited right has converted this unlimited right into 50 limited rights, the proprietor can, by means of the server 11 of the content provider, distribute up to 50 limited rights to the account of any other user having an account at the content provider. When the rights are distributed, the account of the proprietor is decreased by the corresponding number of rights. If, for example, the proprietor gives away 2 limited rights to a friend, the proprietor still has 48 limited rights left.

When the receiver of the 2 limited rights, which receiver now becomes a “proprietor” of digital rights, logs on to the site of the content provider, which provider runs the server 11, by means of her computer 14 and the network 12, the receiver is presented to a list containing the rights tied to the account the receiver has at this specific content provider. Assuming that the unlimited right that was converted was a play right associated with an audio file, the receiver can now double-click the limited right which was transferred to her account. This will effect 16 a playback of the audio file associated to the rights. The audio filed will be streamed 17 to computer 14, and a standard playback module on the computer 14 is used to play the audio file. When the audio file has been played once, the number of limited rights on the account of the receiver will be decreased by one. Alternatively, the receiver can choose to distribute all, or part, of her limited rights to the account of yet another receiver.

As clearly can be seen, the system described in connection to FIG. 1 is advantageous since the digital content and the associated rights are stored on the server 11 of the content provider, the administration and managing of digital rights is simplified, since rights are not distributed outside the server 11. This also implies that the system need not comprise any advanced security facilities for protecting rights. Since the rights are kept within the controlled framework of server 11, an unauthorized third party is prevented from eavesdropping on the network 12 and accessing/stealing the rights.

The fact that the digital content is streamed 17 from the server 11 to computers 13, 14 is advantageous since it prevents a receiver of the content to store it for subsequent manipulation with the intent to access the content without possessing the proper digital rights.

In a schematic representation of a system for converting digital rights according to another embodiment of the present invention, described with reference to FIG. 2, the digital right(s) as well as the associated content are distributed from the server 21 to be stored on the computers 23, 24. Assume that a user purchases, via her computer 23 and the network 22, an audio file and an associated “play unlimited” right from the content provider which runs the server 21. At the purchase, the audio file and the right are downloaded 25 to the computer 23 from the server 21. The purchaser is now a “proprietor” of a digital right. If the proprietor distributes the audio file to another consumer, this consumer can only play the audio file if the proprietor also sends the other consumer the right, in which case the proprietor herself cannot play the file.

If the proprietor of the unlimited right wants to convert the unlimited right into, say, 50 limited rights each giving a proprietor of the right to play the audio file once, she will send 26 her unlimited right together with a conversion instruction to the server 21 via the network 22. This is easily effected by means of a graphical user interface on the computer 23. The software module at the server 21 is activated, and the unlimited right is thus converted to 50 limited rights. In this embodiment, when the unlimited right is converted into limited rights at the server 21, the limited rights are after conversion sent 27 to, and stored at, the computer 23.

The proprietor of the original unlimited right now has converted the unlimited right into 50 limited rights, and can distribute up to 50 limited rights to any other user of choice. Since the limited rights, as well as the content, are stored at the computer 23 of the proprietor, the proprietor herself can now distribute content and associated rights to any other user. For example, the proprietor can send 28 the audio file for which the rights are valid, and an attached limited right giving the other user at the computer 24 the right to play the audio file once, via e-mail across the network 22. When the proprietor at the computer 23 has given one of her limited rights away, 49 limited play rights will remain. Since the limited rights are not personal the user at the computer 24 can choose to redistribute the audio file and the associated play right to any other user.

As described hereinabove, “50 limited rights” is equivalent with 25 limited rights each giving its proprietor the right to access the associate content 2 times or equivalent with 10 limited rights each giving the proprietor 5 accesses. How many accesses a limited right should entail can be arranged by the proprietor of the unlimited right via the graphical user interface of the computer 23.

The fact that the digital content and the associated rights are stored at the computer 23 of a right proprietor is advantageous, since this gives the proprietor a larger degree of freedom in handling and distributing the contents and rights. The proprietor must not, apart from the step of converting an unlimited right to limited rights, operate via the server 21. Another advantage is that, when accessing the digital content, whether the access is of type play, copy, transfer etc., the proprietor need not be in contact with the server 21 of the content provider at the time of access, since the content and associated rights are stored at the computer 23 of the proprietor.

Note that it is possible that authentication may occur between any two, or more, of the appliances between which communication takes place in the described embodiments. This would require the distributed information to be provided with some identifier or authenticator, for example in the form of an identification number or some type of encryption or digital signature. Authentication is typically used to improve the security in a system. Optionally, information is encrypted to prevent unauthorized third parties from eavesdropping on the network and accessing/stealing the distributed information. Exactly what security measures that must be taken by a content provider is a trade-off between the cost for implementing security facilities and the risk that the proprietor of the copyrighted content and/or the content provider will be harmed. If the digital rights are distributed from a server and stored at computers, the right itself must be copy-protected, as somebody otherwise could copy the right and produce an unlimited amount of limited digital rights.

In a schematic representation of the system for converting digital rights according to yet another embodiment the present invention, described with reference to FIG. 3, the software module for converting an unlimited digital right into limited digital rights is implemented at the computer 33 of a right proprietor. Digital content and an associated unlimited digital right is downloaded 35 from the server 31 via the network 32 to the computer 33. When the proprietor of the unlimited right wants to convert the unlimited right into, say, 50 limited rights each giving a proprietor the right to play an audio file once, she will communicate with the software module implemented in her computer 33 via a graphical user interface. The unlimited right and the audio file is stored at the computer 33. The proprietor activates the software module on the computer 33, and the unlimited right is thus converted to 50 limited rights. As described hereinabove in connection with other embodiments, the proprietor is now free to distribute 36 the content and the associated limited rights to any other user as desired, for example the user at the computer 34.

The implementation of the software module at the computer 33 of a digital right proprietor is advantageous, since it gives the proprietor freedom to perform the step of converting an unlimited right into a number of limited rights in her computer 33, without having to send a conversion instruction to the server 31. Consequently, the proprietor does not have to rely on a qualitative connection to the server 31, once the digital content and the associated right have been downloaded 35 to the computer 33. It also has the advantage that the distributor of the software module, typically the content provider or a partner to the provider, does not have to handle the conversion for the users connected to the server 31. DRM is sometimes experienced as restrictive to the content consumers. For content consumers to accept DRM, tools such as the present invention must be as smooth as possible to use when implemented in DRM systems. Preferably, the software module must be protected when implemented at the computer 33 of a right proprietor, since the content provider no longer has the same possibility to supervise the module as in the case when the module is implemented at the server 31 of the content provider. It shall, ideally, not be possible to manipulate the software module such that to an unlimited number of limited digital rights can be produced, or in any way create a digital right which has not been issued by the content provider.

It is understood that combinations of the above described embodiments are possible. Possibly, the digital rights can be distributed to, and stored at, the computers of the users but still the content is stored at the server of the content provider for a proprietor of a digital right to stream. The term “server” can include a number of servers, either arranged as stand-alone servers or interconnected to each other in a network.

It should be noted that the above mentioned embodiments exemplify the invention, and that those skilled in the art will be able to design many alternative embodiments without departing from the scope of the appended claims. The word “comprising” does not exclude the presence of elements or steps other than those listed in a claim. The word “a” or “an” preceding an element does not exclude the presence of a plurality of such elements. In the system claims enumerating several means, several of these means can be embodied by one and the same item of hardware.

1. A method for converting digital rights, characterized in that it comprises the steps of:
storing digital content and an associated unlimited digital right, wherein said unlimited digital right gives a proprietor of the unlimited right access to the content an unlimited number of times; and
converting, when receiving an instruction in accordance therewith, said unlimited digital right into at least one limited digital right, wherein said at least one limited digital right gives a proprietor of the limited right access to the content a limited number of times.

2. The method according to claim 1, wherein digital content and associated digital rights are stored at a server of a digital content provider and the step of converting said unlimited right is performed at said server, and wherein connection is established with the server, for sending the server instructions to convert said unlimited right and accessing the content, from a device with computing capabilities operated by the proprietor of the digital rights.

3. The method according to claim 1, wherein digital content and associated digital rights are stored at a device with computing capabilities, which device is operated by the proprietor of the digital rights, and the step of converting said unlimited right is performed at a server of a digital content provider, and wherein the content is accessed by the device and connection is established with the server for sending the server instructions to convert said unlimited right.

4. The method according to claim 1, wherein digital content and associated digital rights are stored at a device with computing capabilities, which device is operated by the proprietor of the digital rights, and the step of converting said unlimited right is performed at said device, and wherein the content is accessed at the device.

5. A system for converting digital rights, characterized in that it comprises:
storing means arranged to store digital content and an associated unlimited digital right, wherein said unlimited digital right gives a proprietor of the unlimited right access to the content an unlimited number of times; and
processing means arranged to convert, when receiving an instruction in accordance therewith, said unlimited digital right into at least one limited digital right, wherein said at least one limited digital right gives a proprietor of the limited right access to the content a limited number of times.

6. The system according to claim 5, further comprising a device with computing capabilities, wherein the storing means and the processing means are arranged at a server of a digital content provider, and wherein the device, operated by the proprietor of the digital rights, is arranged to establish connection with the server for sending the server instructions to convert said unlimited right and for accessing the content at the server.

7. The system according to claim 5, further comprising a device with computing capabilities, wherein the storing means are arranged at the device and the processing means are arranged at a server of a digital content provider, and wherein the device, operated by the proprietor of the digital rights, is arranged to establish connection with the server for sending the server instructions to convert said unlimited right and arranged to access the content in the storing means.

8. The system according to claim 5, further comprising a device with computing capabilities, wherein the storing means and the processing means are arranged at the device, and wherein the device, operated by the proprietor of the digital rights, is arranged to convert said unlimited right and access the content in the storing means.
